(19) United States
(12) Patent Application Publication
(10) Pub. No.: US 2016/0300021 A1
(43) Pub. Date: Oct. 13, 2016

(54) SECURED MOBILE EMERGENCY PERSONAL MEDICAL INFORMATION SYSTEM

(71) Applicant: Verlin L. Abbott, Carmel, IN (US)

(72) Inventor: Verlin L. Abbott, Carmel, IN (US)

(21) Appl. No.: 14/234,025

(22) PCT Filed: Jul. 24, 2013
(86) PCT No.: PCT/US13/51830

§ 371 Date: Jan. 21, 2014

(51) Int. Cl. G06F 19/00; G06F 21/62

(52) U.S. Cl. CPC G06F 19/323; G06F 21/6245

(57) ABSTRACT

Methods, systems, and apparatus, including computer programs encoded on a computer storage medium, for providing a secured, mobile emergency personal medical information system. In one aspect, a method includes receiving a user's registration information; receiving the user's medical information; writing the user's medical information to a mobile memory device; disabling a write capability of the mobile memory device; and delivering the mobile memory device to the user.

### TECHNICAL FIELD

This specification relates to information storage, and, more particularly, to medical information storage.

### BACKGROUND

Seconds matter in medical emergencies. A first responder's moment of hesitation due to his unfamiliarity with a patient's medical history can lead to accidental harm, or even death of the patient. Even if there is no hesitation, a first responder's actions can still result in inadvertent harm or death because of the first responder's unfamiliarity with the patient's medical history. The same medical actions that can save lives for some can cause injury to others because of allergies, drug sensitivities and incompatibilities, prescription drug regiments resulting in unforeseen drug interactions, and the like. A person's medical information can mean the difference between a lifesaving action and a life costing action within those seconds that matter.

Jewelry, such as bracelets and pendants, can hold only very limited amounts of information, may be costly, is frequently not worn due to fashion considerations, and is typically overlooked by first responders. Paper documentation, such as medical cards and printed documents, is subject to decay, smudging, is water sensitive, and is typically overlooked by first responders. Electronic storage media for medical information is typically ignored by first responders due to the questionable content of the media and the potential for viruses. Thus, there is a need for a personal, portable, resilient, and trustworthy emergency medical information system. The present invention addresses this need.

### SUMMARY

This specification describes technologies relating to secured, mobile emergency personal medical information systems.

In general, one innovative aspect of the subject matter described in this specification can be embodied in methods that include the actions of receiving a user's registration information; receiving the user's medical information; writing the user's medical information to a mobile memory device; disabling further write capability of the mobile memory device; and delivering the mobile memory device to the user. Other embodiments of this aspect include corresponding systems, apparatus, and computer programs, configured to perform the actions of the method, encoded on computer storage devices.

These and other embodiments can each optionally include one or more of the following features. The user's medical information may be obtained through a medical history interview conducted through a web enabled medical interview process. Additional safeguards, such as encryption, can be put into place to ensure the safety of the user's medical history. Additionally, a first responder may be granted access to the user's medical history within a medical information storage system.

Furthermore, these and other embodiments can each optionally include one or more of the following features. The mobile memory device can utilize near field communication (“NFC”) to contactlessly disclose the user's medical information and medical history to a first responder's NFC enabled device. NFC communication is a well understood technology and not discussed within this application. Some implementations can utilize a matching encrypted security code and transporting access key to further ensure the safety of the user's medial information and history.

Particular embodiments of the subject matter described in this specification may be implemented so as to realize one or more of the following advantages. A user's emergency medical information can be formatted and streamlined for improved access and comprehension by a first responder. Additionally, the user's entire emergency medical information is contained within, or accessible through, a single device. This in turn also helps to ensure that a first responder will access the user's emergency medical information. Finally, knowing that a first responder will likely be able to access user's emergency medical information helps to increase the user's peace of mind.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example of a system view of a mobile memory device with wear leveling.

FIG. 2 is a block diagram of an example environment in which secured, emergency personal medical information is received and written to a mobile memory device.

Like reference numbers and designations in the various drawings indicate like elements.

FIG. 3 is a block diagram of an example process of the secured mobile personal medical information system.

FIG. 4 is block diagram of an example computer system that can be used to receive a user's registration and medical information and to write the medical information to a mobile memory device.

### DETAILED DESCRIPTION

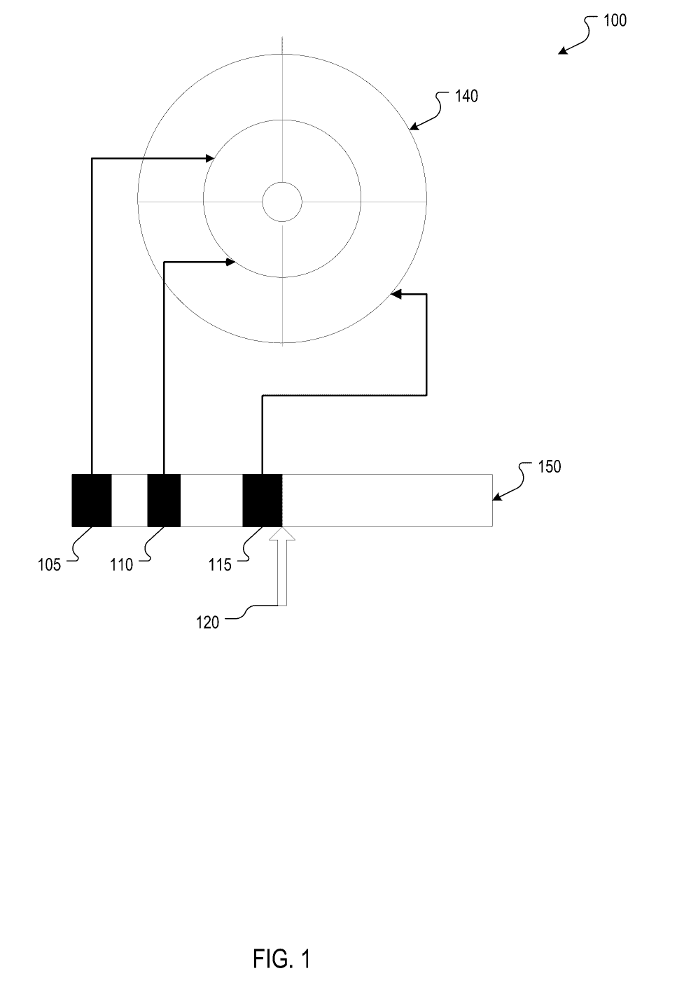

FIG. 1 is a block diagram 100 of an example view of a mobile memory device 150 with wear leveling. In some implementations, the mobile memory device 150 is composed of solid state memory that cannot be infinitely written to without harm, such as USB key storage device. In some implementations, the mobile memory device is further enabled to be a passive NFC device such that the mobile memory device can be interacted with at a close distance by a NFC initiator. Typically, the distance of possible interaction is small and normally ranges from 3 to 6 centimeters, although systems having greater range may also be used.

Typically, the mobile memory device 150 is of a size and weight suited for mobile and personal usages and has a common and standard interface. For example, the mobile memory device 150 could be a USB flash drive, a solid state drive, or similar device.

In a hard disk drive, data physically resides within specific locations upon the hard disk. Each data memory location on a hard disk is in a specific location and that location does not change over time. A system reading from or writing to a specific location on a hard disk drive results in reading from or writing to a specific physical location of the hard disk.

However for some implementations, the mobile memory device 150 is composed of memory that cannot be infinitely written to without harm. Writing and re-writing to a specific location in the mobile memory device 150 would cause that specific memory location to quickly fail. Wear leveling is used to prevent the pre-mature failure of memory in the mobile memory device 150. However, as explained below, some implementations utilize an altered wear leveling process.

Wear leveling is a process where memory writes are distributed throughout the memory locations of a device. To accomplish wear leveling, the mobile memory device 150 maintains a logical address map. The logical address map maps the locations of a logical hard disk 140 to the actual memory locations of the mobile memory device 150. Using the logical address map, the mobile memory device 150 presents a façade of a hard disk 140 to a system while the mobile memory device 150 manages the actual locations that data is written to or read from. For example, while a computer system might believe it is writing data to a specific location of a logical hard drive 140, the computer system may actually be writing to a location known to and managed by the mobile memory device 150. Diagram 100 demonstrates the logical address map by depicting the mapping of data stored in the actual memory locations 105, 110, and 115 to the logical addresses on the logical hard drive 140.

Because the mobile memory device 150 uses wear leveling to distribute memory writes, writing data to a mobile memory device 150 can be viewed as similar to writing data to a magnetic tape memory based device. Writing to a magnetic tape memory based device is accomplished by writing to the next sequentially available memory location. Similarly, writing to the mobile memory device 150 is accomplished by writing to the next sequentially available memory location. In diagram 100, the next available memory location is indicated by the write pointer 120. For example, a computer system might specify that it is writing to the location on the logical hard disk 140 currently logically mapped to by memory location 105. Because the mobile memory device 150 uses wear leveling, the writing to memory will actually occur where the write pointer 120 is pointing.

One example implementation utilizes a modified wear leveling process. The modified wear leveling process permits a limited number of writes or write sessions to occur before permanently disabling the write to capability of the mobile memory device 150. A write session is a series of writes. For example, the modified wear leveling process enables only enough writes to write a user's medical history to the mobile memory device 150. Note that the disabling of the memory device's write capability prevents the alteration and/or deletion of information stored in the mobile memory device 150.

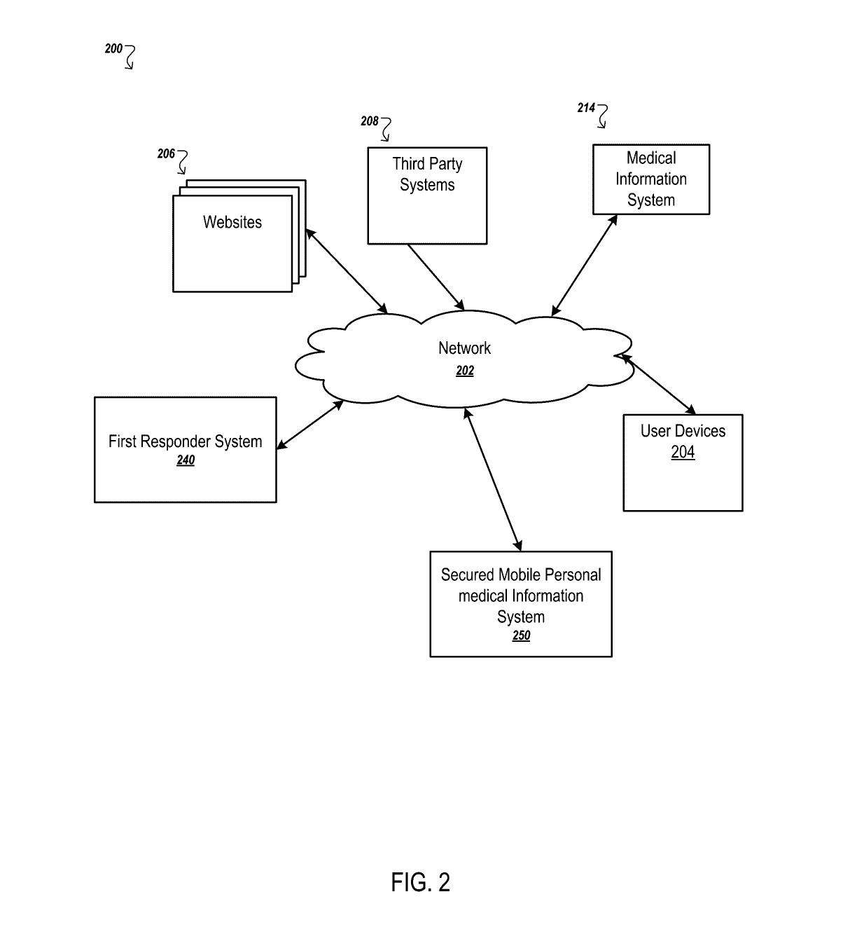

FIG. 2 is a block diagram 200 of an example environment in which secured, emergency personal medical information is received and written to a mobile memory device 150. For example, the environment 200 includes a first responder system 240 that manages and dispatches first responders, personnel and resources, to emergencies. The example environment 200 also includes a network 202, such as a local area network (“LAN”), a wide area network (“WAN”), wireless communications, the Internet, combinations thereof, and the like. The network 202 connects user devices 206, websites 204, third party systems 208, medical information systems 214, and portions of the secured mobile personal information system 250. The example environment 200 may include many websites 204, user devices 206, and third party systems 208.

A website 204 is one or more resources associated with a domain name and hosted by one or more servers. Typically, a website 204 is a collection of web pages formatted in hypertext markup language (“HTML”) that can contain text, images, multimedia content, and programming elements, such as scripts. Each website 204 is maintained by a publisher, which is an entity that controls, manages and/or owns the website 204. In some implementations, the website 204 is a registration website where users can go to register to utilize the secured mobile personal information system 250. In some implementations, the website 206 is a personal medical information gathering website where users can go to submit their personal medical information for usage in the secured mobile personal medical information system 250. In some implementations, the website 204 is a website where users can go to submit their authorization for the secured mobile personal medical information system 250 to access a medical information system 214. For example, a user could go to a website 206 to both register to use the secured mobile personal medical information system 250 and to give his authorization for the secured mobile personal medical information system 250 to access the user's medical information through accessing a medical information system 214.

A user device 206 is an electronic device that is under control of a user and is capable of requesting and receiving resources over the network 202. Example user devices 206 include personal computers, mobile communication devices, and other devices that can send and receive data over the network 102. A user device 206 may include a user application, such as a web browser, to facilitate the sending and receiving of data over the network 202. A user device 206 can interact with a website 204 to exchange various data and information. For example, a user can utilize a personal computer to give his authorization for the secured mobile personal medical information system 250 to access his medical records in a medical information system 214.

A third party system 208 is an information system of a third party. The user may be in some sort of privity with the owner of the third party system 208. Additionally, the user may also authorize the third party to act upon the user's behalf for the purpose of registering with the secured mobile personal information system 250. For example, a third party membership organization, such as the American Automobile Association (AAA), could provide access to the secured mobile personal medical information system as part of AAA's membership benefits.

A medical information system 214 is a system storing a user's medical information in such a way that the user's medical information is electronically retrievable. Typically, retrieval of a user's medical information is permitted only under authorized conditions. The medical information system 214 may also employ various forms of data securing technologies, such as password or multiple password protected data, data encryption, combinations thereof, and the like. For example, the US federal government provides every medical professional with a unique identifier. Medical professionals can access the information within a medical information system 214 by providing their unique identifier.

A first responder system 240 is typically a combination of skilled people, technology, transportation and delivery mechanisms enabling skilled people to come to the aid of victims or injured individuals. For example, a first responder system 240 can include medical dispatch services, telecommunication services, transportation services such as emergency vehicles, portable medical technologies, and the like. In some implementations, the first responder system 240 includes technologies enabling first responders to interface with and obtain emergency medical information from a mobile memory device 150. In some implementations, the first responder system 240 includes technologies enabling first responders to interface with the mobile memory device 150 and to interface with the medical information system 214. In some implementations, the first responder system 240 includes technologies enabling first responders to interface with the mobile memory device 150 and to interface with the secured mobile personal medical information system 250. For example, if the mobile memory device 150 was a USB flash drive, the first responder system 240 can include a device, such as a portable computer, having a USB port and a wireless networking card. The USB port enables the access of the mobile memory device 150 while the networking card enables interaction with the secured mobile personal information system 250 and/or the medical information system 214 via the network 202.

The secured mobile personal medical information system 250 may be composed of a data processing apparatus capable of receiving personal medical information, a user interface permitting a user to input information, a data processing apparatus capable of writing data to a mobile memory device 150 configured to accept a limited number of writes, a mobile memory device 150, first responder training, static cling decals and other high notice alerts to first responders informing them to look for a mobile memory device 150, rules for user handling and care of the mobile memory device 150, and an information store. In some implementations, the secured mobile personal medical information system 250 also includes a data processing apparatus capable of encrypting information. The standardized nature of the rules for user handling and care of the mobile memory device 150 help to ensure that first responders will locate and utilize the mobile memory device 150 during a medical emergency.

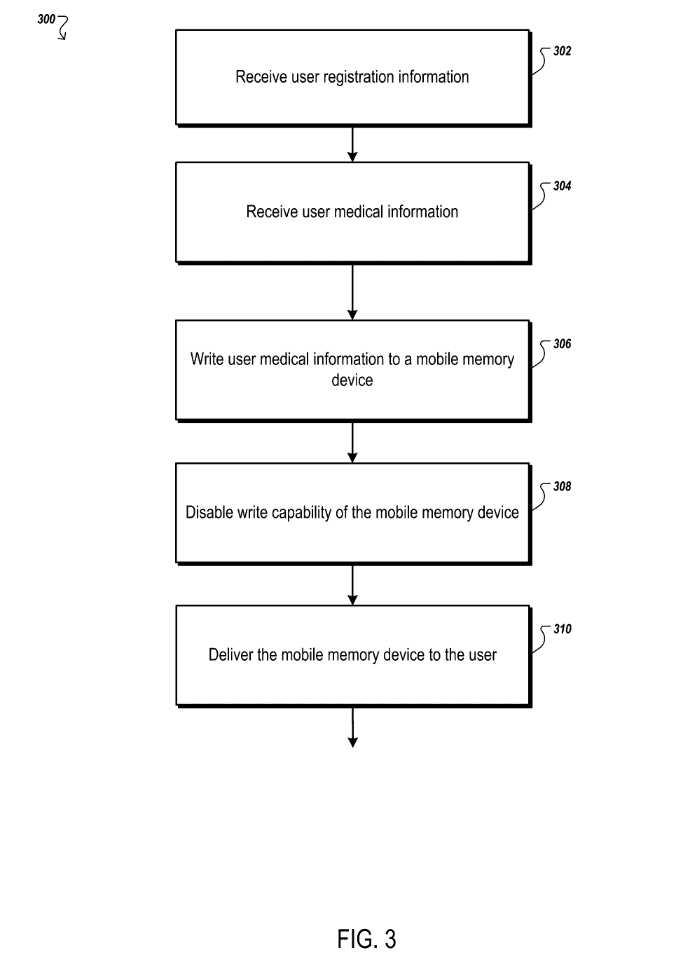

FIG. 3 is a block diagram of an example process 300 of the secured mobile personal medical information system 250. The mobile personal medical information system 250 receives user registration information (302). In some implementations, the user registration information is received from a website 206. In such implementations, the user registration information can consists of the user's name, various identifying information such as a social security number, various passwords including but not limited to passwords used to access medical records, payment information such as a credit card account number, and the like. In some implementations, the user registration information can come from a third party system 208.

The secured mobile personal medical information system 250 receives the user's medical information (304). In some implementations, the user's medical information is gathered from the user via a website 206 implementing an automated medical information gathering application. Optionally, such automated medical information gathering applications employ techniques intended to gather medical information that the user himself may be unaware of For example, an automated medical information gathering application could query the user over the user's food allergies. Some food allergies can indicate various drug sensitivities and incompatibilities. Similarly, the automated medical information gathering application can also query the user over the user's drug regiments.

In some implementations, the user's medical information is verified. In implementations gathering the user's medical information from the user, verification of the medical information can be accomplished through methods of interaction intended to uncover answer or information inconsistencies. In some implementations, the inconsistencies are detected through multiple questions, cross referencing of stated medical conditions and/or use of medicine, and/or the like. For example, multiple questions pertaining to the same medical issue can be posed to the user during the obtaining of the user's medical information. Inconsistent answers can be resolved through additional questioning or re-answering questions. In implementations that gather the user's medical information from medical information systems 214, medical data verification can be accomplished through data inconsistency, statistical analysis, machine learning, and the like.

In some implementations, the user's medical information may not be gathered directly from the user. Instead, some implementations, having obtained the user's authorization and medical information system passwords, and obtain the user's medical information from a medical information system 214. In some implementations, no medical information is obtained, but rather the user's authorization and medical information system passwords are maintained for future reference.

In some implementations, the user's medical information is written to the mobile memory device 150 (306). Note that the medical information is written to the mobile memory device 150 under controlled conditions. For example, data verification, integrity, and contamination prevention measures, such as virus scans, are used to ensure purity and safety of the medical information. The medical information is then stored in a secure environment and later accessed to write the medical information to the mobile memory device 150.

Thus, the written medical information is virus free and as accurate as the originally received medical information. The medical information may be written to the mobile memory device 150 in a number of different storage formats. The number of different storage formats helps to ensure that a first responder's equipment will be able to retrieve the medical information from the mobile memory device 150. Example formats include but are not limited to various word processor formats, universal word processor formats, such as rich text format, straight text, comma denoted text fields, marked text formats such as XML, and the like. In some implementations, the medical information is first encrypted before being written to the mobile memory device 150. The encrypted nature of the written medical information helps to prevent unauthorized access to the written medical information should the mobile memory device 150 fall into the wrong hands. Additionally, some implementations are further protected by also receiving a matching encrypted security code and transporting access key. For example, the matching encrypted security code and transporting access key prevents non-authorized NFC initiator devices from communicating and accessing the information of a NFC enabled mobile memory device 150.

Some implementations may not write any medical information to the mobile memory device 150. Instead, the secured mobile personal medical information system associates a unique identifier with the mobile memory device 150 and writes the unique identifier to the mobile memory device 150. Should the mobile memory device 150 be accessed by a first responder, the unique identifier is used to retrieve the user's emergency medical information. In some systems, the user's emergency medical information is retrieved from the secured mobile personal information system 250. The secured mobile personal information system 250 of some implementations retrieves the user's medical information from an internal data store. The secured mobile personal information system 250 of other implementations may, on the fly, access a medical information system 214 to obtain the user's medical information before relaying the medical information to a first responder. Such implementations may use the first responder's medical identification number when accessing the medical information system 214. Such implementations may provide the user's entire medical information instead of only the user's emergency medical information.

Disabling the write capability of the mobile memory device 150 (308) helps to prevent future alterations of the written medical information. Additionally, writing the medical information to the mobile memory device 150 under controlled conditions subsequently helps to ensure that the mobile memory device 150 is virus and malicious application free. Disabling the write capability of the memory device 150 helps to ensure that the memory device 150 remains virus and malicious application free. Thus, first responders can access the contents of the mobile memory device 150 with a high degree of confidence that the medical information is accurate and safe for their devices.

However, in some implementations the write capacity of the mobile memory device 150 is not entirely disabled. In those implementations, a portion of the memory of the mobile memory device continues to be enabled but only accessible by the mobile memory device 150 itself. When the mobile memory device 150 is interacted with, the mobile memory device 150 queries the other device and writes the received information to the enabled portion of memory. This enables the mobile memory device 150 to track the devices that have attempted to interact with mobile memory device 150.

The mobile memory device is delivered to the user (310). As previously stated, the mobile memory device 150 is of a size and weight suited for mobile and personal usages. For example, the mobile memory device 150 is typically small enough to fit on a key chain. Much smaller sizes are possible with the mobile memory device 150 of some implementations being contained within jewelry, held in the user's wallet, and the like. However, the rules for user handling and care of the mobile memory device 150 persuade against keeping the mobile memory device 150 in uncommon locations. For example, the rules for user handling and care of the mobile memory device 150 may suggest keeping the mobile memory device 150 on the user's key chain instead of clipping the mobile memory device 150 to a jacket zipper.

In some implementations, additional mechanisms are used to help ensure that a user's mobile memory device 150 is found by a first responder. For example, some implementations include static cling decals and other high notice alerts. The static cling decals and other high notice alerts work to instruct a first responder to look for the user's mobile memory device 150. Additionally, the mobile memory device 150 may glow in the dark, may be colored with a day glow color, may include a blinking light emitting diode, may include an embedded radio frequency identification chip, be NFC enabled, and the like. In some implementations, for example those implementations that are NFC enabled, the first responder can locate and interact with the mobile memory device 150 by scanning or waving a NFC enabled initiator device such as mobile computer, NFC enabled cell phone, and the like, over the patient's body.

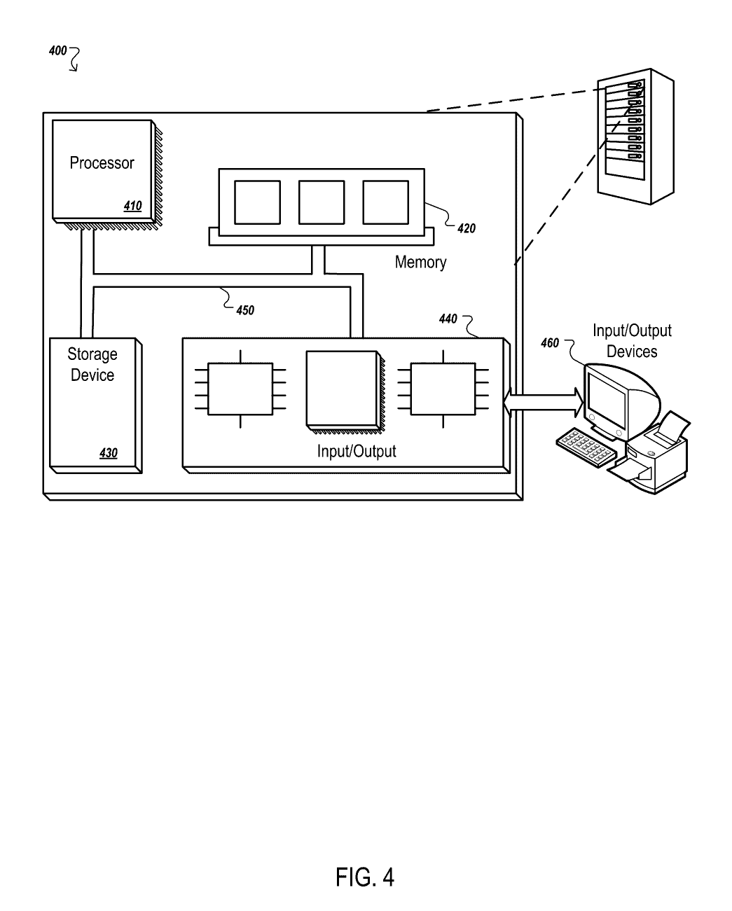

FIG. 4 is a diagram of an example computer system 400 that can be used to receive a user's registration and medical information and to write the medical information to a mobile memory device. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, a NFC communication device, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A method comprising:
receiving, by a computer, a user's registration information;
receiving, by the computer, the user's medical information;
writing, by the computer, the user's medical information to a mobile memory device, wherein the mobile memory device implements wear-leveling;
disabling a write capability of the mobile memory device;
delivering the mobile memory device to the user.

2. The method of claim 1, wherein disabling a write capability of the mobile memory device further comprises maintaining a portion of a memory of the mobile memory device writeable such that only the mobile memory device can write to the portion of the memory of the mobile memory device.

3. The method of claim 1, wherein the user's medical information is received from a medical history interview.

4. The method of claim 3, wherein a medical history interview is conducted through a web enabled medical interview process.

5. The method of claim 1, wherein the user's medical information is received from a medical information system.

6. The method of claim 1, wherein the user's medical information is verified.

7. The method of claim 1, wherein writing the user's medical information to a mobile memory device further comprises encrypting the user's medical information.

8. The method of claim 1, wherein writing the user's medical information to a mobile memory device comprises:
writing the user's medical information to a secured mobile personal medical information system;
associating a unique identifier with the user's medical information;
writing the unique identifier to the mobile memory device;
storing the association of the unique identifier with the user's medical information in a secured mobile personal medical information system.

9. The method of claim 1, further comprising:
obtaining the mobile memory device;
retrieving a user's medical information from the memory device;
administering medical care to the user, the medical care based at least in part on the user's medical information.

10. The method of claim 9, wherein retrieving the user's medical information from the mobile memory device comprises:
interfacing the mobile memory device with a first responder's portable computer;
reading, by the portable computer, the user's medical information from the mobile memory device.

11. The method of claim 10, wherein interfacing the mobile memory device with the first responder's portable computer is accomplished through near field communication.

12. A system comprising:
one or more computers;
a mobile memory device;
instructions for execution by the one or more computers, the instructions comprising instructions to:
receive a user's registration information;
receive a user's medical information;
write the user's medical information to the mobile memory device;
disable write capability of the mobile memory device.

13. The system of claim 12, wherein the instructions for execution by the one or more computers further comprise instructions to:
write the user's medical information to a secured mobile personal medical information system;
associate a unique identifier with the user's medical information, the unique identifier generated by a secured mobile personal medical information system;
write the unique identify to the mobile memory device;
store the association of the unique identifier with the user's medical information in the secured mobile personal medical information system.

14. The system of claim 12, wherein the instructions for execution by the one or more computers further comprise instructions to:
disable write capability of the mobile memory system such that a portion of a memory of the mobile memory device remains writable such that only the mobile memory device can write to the portion of the mobile memory device.

15. The system of claim 14, wherein the instructions for execution by the one or more computers further comprise instructions to:
encode the mobile memory device such that the mobile memory device writes to the portion of memory of the mobile memory device information concerning subsequent interfaces with the mobile memory device.

16. The system of claim 12, wherein the instructions for execution by the one or more computers further comprise instructions to encrypt the user's medical information.

17. The system of claim 12 further comprising:
a first responder's device, the device capable of interfacing with the mobile memory device and able to present information to the first responder.

18. The system of claim 17 wherein the first responder's device is capable of interfacing with the mobile memory device through near field communication.

19. The system of claim 17 wherein the first responder's device presents information to the first responder obtained from a secured mobile personal medical information system and associated with a unique identifier obtained from the mobile memory device.
